(19) United States
(12) Patent Application Publication
(10) Pub. No.: US 2017/0171639 A1
(43) Pub. Date: Jun. 15, 2017

(54) METHOD AND ELECTRONIC DEVICE FOR LOADING ADVERTISEMENT TO VIDEOS

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Wenlong BAI, Beijing (CN)

(21) Appl. No.: 15/239,802

(22) Filed: Aug. 17, 2016

Related U.S. Application Data
(63) Continuation of application No. PCT/CN2016/089270, filed on Jul. 7, 2016.

(30) Foreign Application Priority Data
Dec. 9, 2015 (CN) 201510908408.3

(51) Int. Cl. H04N 21/81; H04N 21/234; H04N 21/24

(52) U.S. Cl. CPC H04N 21/812; H04N 21/2407; H04N 21/23424

(57) ABSTRACT

The present disclosure relates to a method and an electronic device for loading advertisements to video, and the method includes: monitoring content information of a video; judging whether there is an advertisement matching with the content information in an advertisement library; and loading the advertisement to the video when there is an advertisement matching with the content information in the preset advertisement library.

### CROSS-REFERENCE TO RELATED APPLICATION

This application is a continuation of International Application No. PCT/CN2016/089270, with an international filing date of Jul. 7, 2016, which claims priority to Chinese Patent Application No. 201510908408.3, filed with State Intellectual Property Office on Dec. 9, 2015, titled “METHOD AND DEVICE FOR LOADING ADVERTISEMENTS TO VIDEO”, all the contents of which are incorporated herein by reference.

### TECHNICAL FIELD

The present disclosure relates to the technical field of video technologies, and in particular, to a method and an electronic device for loading advertisements to video.

### BACKGROUND

With the wide popularization of networks, many users have been used to watching a video on line via a terminal. Many companies expect to load advertisements to video. In one way, fixed-mode advertisements are directly loaded to a video, but in such a way, video watching experience of a user would be certainly influenced, which may influence the play rate of the video. In the other way, the content of the movie is modified directly, thus it seems to the user that the loaded advertisements product was in a movie picture when the video is filmed, but in such a way, the advertising cost will be increased greatly

### SUMMARY

In order to overcome the problems in prior art, the disclosure provides a method and an electronic device for loading advertisements to video.

According to the first aspect of an embodiment of the disclosure, there provides a method for loading advertisements to video, including:

monitoring content information of the video;

judging whether there is an advertisement matching with the content information in an advertisement library; and

loading the advertisement to the video when there is an advertisement matching with the content information in the preset advertisement library.

According to the second aspect of an embodiment of the disclosure, there provides a non-transitory computer-readable storage medium on which computer executable instructions are stored, when executed, the computer executable instructions may carry out any one of the above methods for loading advertisements to video according to the disclosure.

According to the third aspect of an embodiment of the disclosure, there provides an electronic device that includes: at least one processor and a memory in communication connection with the at least one processor; wherein the memory stores instructions executable by the at least one processor, wherein the instructions are configured for executing any one of the above methods for loading advertisements to video according to the disclosure.

### BRIEF DESCRIPTION OF THE DRAWINGS

One or more embodiments are illustrated by way of example, and not by limitation, in the figures of the corresponding accompanying drawings, wherein elements having the same reference numeral designations represent like elements throughout. The drawings are not to scale, unless otherwise disclosed.

FIG. 1 is a flow chart illustrating a method for loading advertisements to video provided by an embodiment of the present disclosure;

FIG. 2 is a flow chart of Step S120 in FIG. 1;

FIG. 3 is a flow chart of Step S130 in FIG. 2;

FIG. 4 is an another flow chart of Step S130 in FIG. 1;

FIG. 5 is a flow chart illustrating a method for loading advertisements to video provided by an embodiment of the present disclosure;

FIG. 6 is a schematic diagram illustrating a device for loading advertisements to video provided by an embodiment of the present disclosure;

FIG. 7 is a schematic diagram of an advertisement judging unit shown in FIG. 6;

FIG. 8 is a schematic diagram of an advertisement loading unit shown in FIG. 6;

FIG. 9 is another schematic diagram of an advertisement loading unit shown in FIG. 6;

FIG. 10 is a schematic diagram illustrating a device for loading advertisements to video provided by an embodiment of the present disclosure; and

FIG. 11 is a diagram illustrating a hardware structure of an electronic device on which a method for loading advertisements to video is executed provided by an embodiment of the present disclosure.

### DETAILED DESCRIPTION

Exemplary embodiments, of which the examples are shown in the drawings, will be described in detail hereinafter. When the description below refers to the drawings, the same numeral employed in different drawings represents the same or similar element, unless otherwise mentioned. The implementation modes described in the following exemplary embodiments do not represent all implementation modes consistent with the disclosure. Instead, they are only examples of the device and the method consistent with some aspects of the disclosure as described in detail in the claims appended.

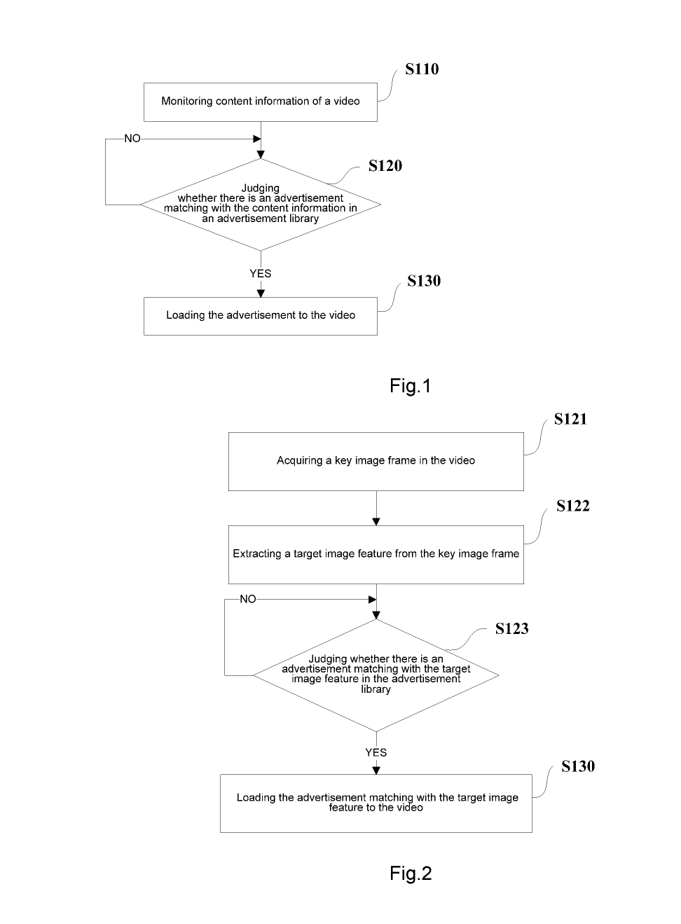

In order to solve the related problem, first of all, one embodiment of the disclosure provides a method for loading advertisements to video. As shown in FIG. 1, the method may include the steps of:

In step S110: content information of a video is monitored;

According to this embodiment, the method may be applied to a server. When a video is played in a terminal, the content information of the video that is being played may be monitored in real time; the content information may include: image information and audio information.

Generally, a video includes a video picture consisted of image frames and an audio corresponding to the video picture. Wherein, the video picture is consisted of multiple image frames, and the multiple image frames are played successively to form a video picture, while each image frame corresponds to an image which may include human images, building images, etc.; the audio in the video may include music, human speech, etc. Therefore, the image information and the audio information in the video may be monitored.

In step S120: it is judged whether there is an advertisement matching with the content information in an advertisement library.

At present, advertisements may be divided into various classes. Generally, advertisements are product advertisements, for example, advertisements of communication tools, traffic tools, drinks or dresses, etc. Therefore, an advertisement that needs to be displayed in a video may be added to an advertisement library, so that it is possible to judge whether there is an advertisement matching with the content information in the video in the advertisement library according to the content information in the video.

In step S130: when there is an advertisement matching with the content information in the preset advertisement library, the advertisement is loaded to the video.

Exemplarily, when the video picture in a video that is being played is that a user is using a mobile phone, that is, it is monitored that the content information of a video played contains a “mobile phone” picture, if there is a mobile phone advertisement in the pre-established advertisement library, the advertisements may be called up and loaded to an image frame of the video, so that the advertisement may be consistent with the video content. Thus, it is more acceptable to the user.

It should be noted that, by an advertisement that matches with the content information in the video, it may not only mean that in the content information of the video there is contents similar to or consistent with the product advertisement, but also mean that the scene of the video is consistent with the advertisement. For example, when it is detected that the video being played is a World Cup game, in case one party makes a goal, a corresponding beer advertisement of a certain brand may be immediately loaded to the video picture; for example, the audio of the loaded advertisement may be: “** beer cheers for your World Cup”, and the image of the loaded advertisement may be a beer image of the certain brand displayed in the video. Thus, a user watching this video generally will not feel disgusted to such a loaded advertisement; instead, the user may be willing to accept such an advertisement, and a better advertising effect may be attained.

In the method for loading advertisements to video according to the disclosure, by monitoring the content information of a video played, it is possible to judge whether there is an advertisement matching with the content information of the video in an advertisement library; if yes, the corresponding advertisement is loaded to the video, so that the advertisement loaded to the video may be perfectly integrated with the content of the video. Thus, an excellent advertising effect may be attained without a need to directly modify the movie content of the video, and the phenomenon of user antipathy caused by the mismatch between the video content and the advertisement loaded in the traditional advertising mode may also be avoided.

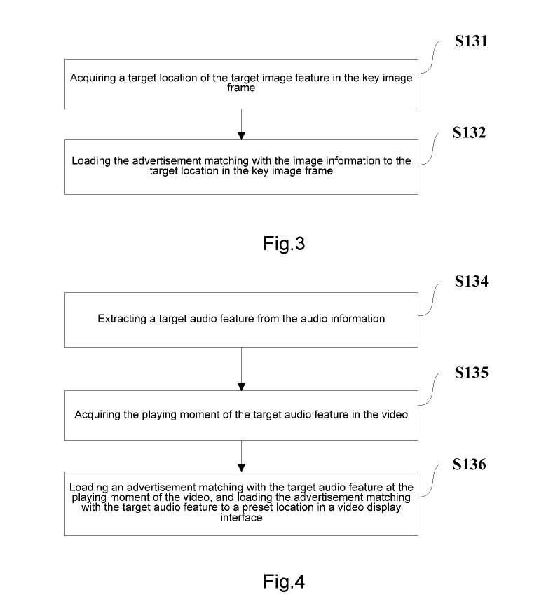

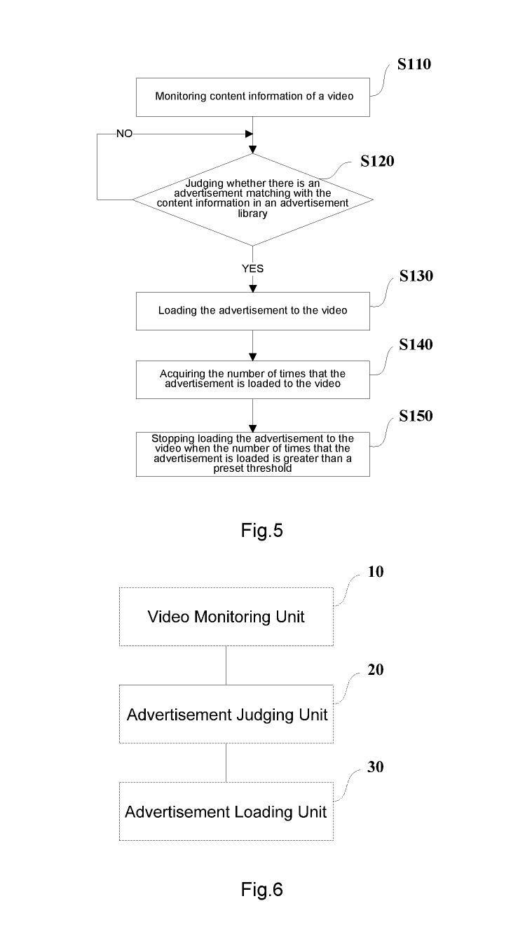

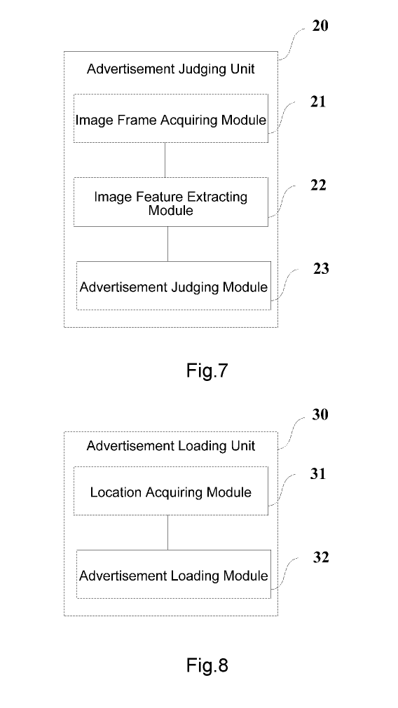

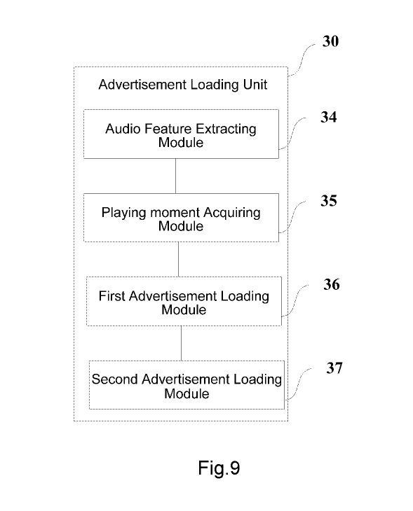

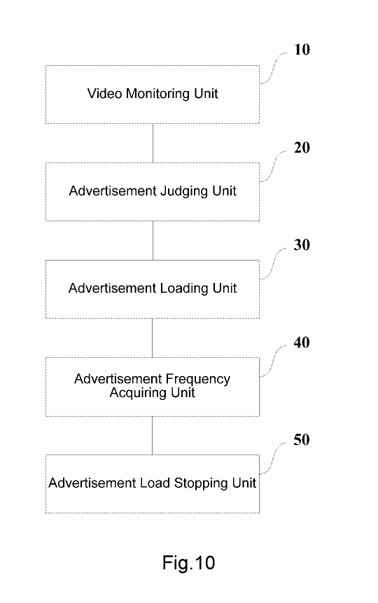

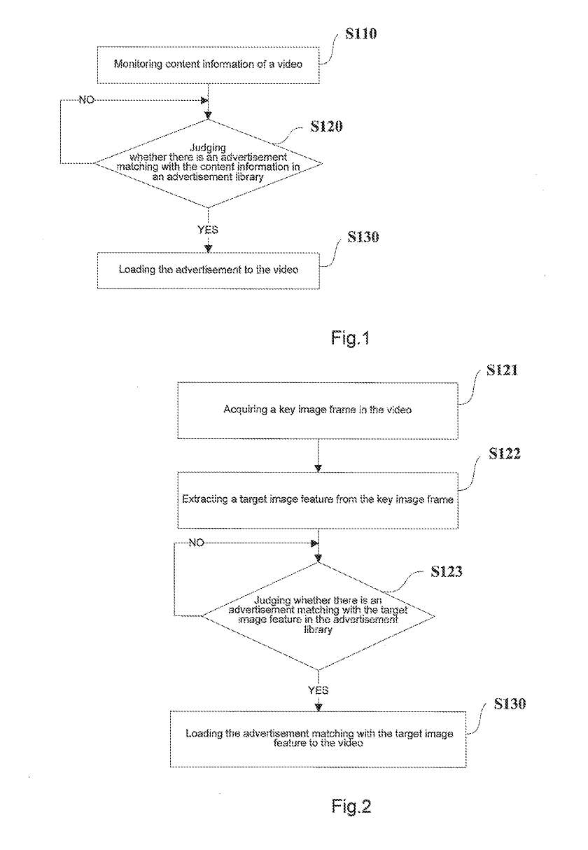

As a detailing of the method of FIG. 1, in order to explain in detail how to judge whether there is an advertisement matching with the content information of the video in an advertisement library, in another embodiment of the disclosure, the content information may be image information, as shown in FIG. 2; the Step S120 may include:

In step S121: a key image frame in the video is acquired.

A video picture is consisted of a plurality of image frames; during video play, image information in each image frame of a video may be detected, and an image frame containing an target object is taken as a key image frame; for example, the target object may be a mobile phone, a car or a computer, etc. As an example, when an advertisement relevant to a mobile phone, a car or a computer needs to be loaded to a video, an image frame containing the target object (for example, a mobile phone, a car or a computer) is taken as the key image frame. For the algorithm for extracting key image frames from the video, an image frame containing the target object may be determined as a key image frame by processing the video, for example, by detecting texture features and color features of an image frame in the video. Additionally, during the determination of the key image frame, it may also calculate the similarity between other image frames to be processed and the key image frame determined, and when the degree of similarity is greater than a preset threshold, the image frame with a similarity degree greater than the preset threshold will become a key image frame.

As an example, one algorithm for extracting a key image frame may be as follows: 1) extracting color features of an image frame in the video, and calculating the color distance between two adjacent image frames; 2) extracting texture features of an image in the video, and calculating the texture distance between two adjacent image frames; 3) normalizing the color distance and the texture distance of two adjacent image frames, and obtaining a composite distance after processing; 4) acquiring a preliminary key frame according to a set threshold and the composite distance by a distance summarization; 5) performing saltation detection on the key frame selected preliminarily, and acquiring a final key frame.

In another example, in Key Frame Extraction Algorithm Based On Image Similarity (Fujian Computer, No. 5, 2009), He Xiang and Lu Guanghui proposed an algorithm for extracting a key image frame in a video, by which a key image frame may be nicely extracted from a video. There are various mature algorithms for extracting a key image frame from a video, and no specific algorithms will be described again here.

In step S122: a target image feature is extracted from the key image frame.

Exemplarily, when a key image frame in the video is acquired, because the key image frame contains a target object (for example, the target object may be a mobile phone, a car or a computer), the key image frame needed to be further processed so as to specifically determine whether the target object in the image frame is a mobile phone, a car or a computer, so that a relevant advertisement may be loaded. A practical processing on the key image frame may include the steps of: key image frame preprocessing, image segmentation, feature extraction and feature recognition. Exemplarily, if it is determined that a certain image frame in the video is a key image frame, in order to further determine what image feature is specifically included in the key image frame (for example, the image feature may be specifically a mobile phone, a car or a computer), the key image frame may be firstly processed into a gray level image via color processing, and then the gray level image obtained may be processed into a binarized image via a binarization algorithm, afterwards, an region of interest in the image may be extracted, and the target image feature in the key image frame may be obtained after processing; the target image feature obtained may be further matched with a template in a template library, so that the target object in the key image frame may be recognized, for example, as a mobile phone, etc.

In step S123: it is judged whether there is an advertisement matching with the target image feature in the advertisement library.

When there is an advertisement matching with the target image feature in the advertisement library, it turns to Step S130.

When there is no advertisement matching with the target image feature in the advertisement library, it returns to Step S123 and continues to perform the judging step.

A correlation between the target image feature and an advertisement in the advertisement library may be pre-established, or a correlation between the target image feature and an advertisement in the advertisement library may be established via a recognition algorithm. Exemplarily, when it is recognized that the target image feature is a mobile phone, it may look up an advertisement related to mobile phones in the advertisement library. Then, the advertisement matching with the target image feature may be loaded to the corresponding image frame in the video.

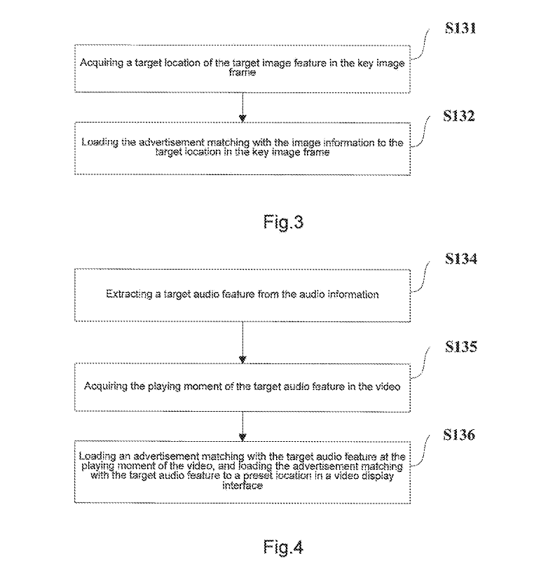

As a detailing of the method of FIG. 1 in conjunction with FIG. 2, in order to illustrate in detail which location in the image frame the corresponding advertisement found in the advertisement library would be specifically superposed to, in another embodiment of the disclosure, as shown in FIG. 3, the Step S130 may include:

In step S131: the target location of the target image feature in the key image frame is acquired.

In step S132: the advertisement matching with the image information is loaded to the target location in the key image frame.

The advertisement matching the image information is loaded to the target location in the key image frame.

Because the specific location of the target image feature in different image frames may be different, in order to obtaining a better advertising effect, the advertisement may be placed in the vicinity of the location of the target image feature in the video picture. Exemplarily, when it appears in an image frame of the video that a user is using a mobile phone, an advertisement picture relevant to mobile phones may appear in the vicinity of the location of the mobile phone picture in the image frame.

Because not only image frames, but generally also audios, may exist in a video that is played, as a detailing of the method in FIG. 1, in order to illustrate in detail how a corresponding advertisement is combined with an audio in the video and loaded to the video, in another embodiment of the disclosure, as shown in FIG. 4, when the content information is an audio information, the Step S130 may further include:

In step S134: a target audio feature is extracted from the audio information.

In step S135: a playing moment of the target audio feature in the video is acquired.

In step S136: an advertisement matching with the target audio feature is loaded at the playing moment of the video, and the advertisement matching with the target audio feature is loaded to a preset location in a video display interface.

In the present disclosure, audio recognition is used. Specifically, a prior art audio recognition algorithm may be employed; audio signals in the video may be pre-processed, the noise therein may be filtered out by technical means such as filtering and the like, and then the target audio feature therein may be recognized via audio recognition. The target audio feature may contain a certain audio; for example, an audio containing “mobile phone” may be taken as the target audio feature. An advertisement corresponding to the target audio feature is found in the advertisement library and loaded to a preset location on the video display interface, so that the advertisement loaded can be more consistent with the content information in the video, and a user can accept the advertisement in a better way, thereby a better advertising effect may be attained. Exemplarily, the preset location may be on the bottom right corner of the video play interface, etc.

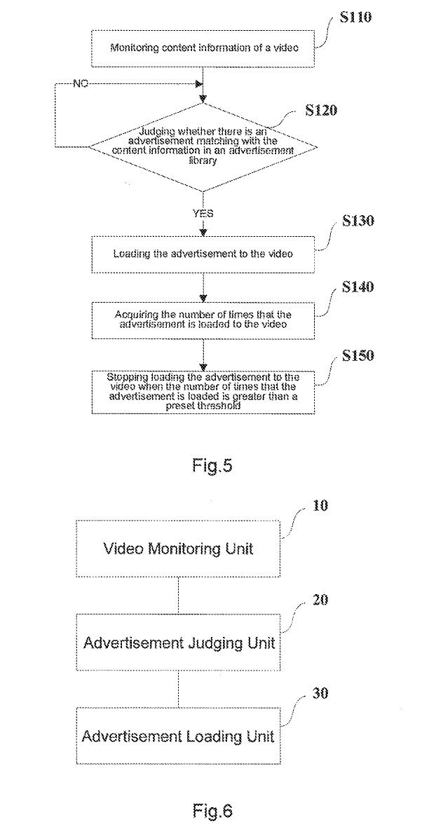

In another embodiment of the disclosure, based on FIG. 1, as shown in FIG. 5, the method for loading advertisements to video according to the disclosure may further include the steps of:

In step S140: the number of times that the advertisement is loaded to the video is acquired.

In step S150: when the number of times that the advertisement is loaded is greater than a preset threshold, a continuous load of the advertisement to the video is stopped.

By the above method according to the embodiment of the disclosure, an advertisement loaded to a video may be perfectly integrated with the content in the video; however, if the number of times that the advertisement is loaded to the video is too large, the mood of the user that watches the video would be influenced. Therefore, when the number of times that the advertisement is loaded to the video is greater than a certain number, it needs to stop loading advertisements to video.

In the method for loading advertisements to video according to the disclosure, by monitoring the content information of a video played, it is judged whether there is an advertisement matching with the content information of the video in an advertisement library; if yes, the corresponding advertisement will be loaded to the video, so that the advertisement loaded to the video may be perfectly integrated with the content of the video. Thus, an excellent advertising effect may be attained without a need to directly modify the movie content of the video, and the phenomenon of user antipathy caused by the mismatch between the video content and the advertisement loaded in the traditional advertising mode may also be avoided.

An advertisement corresponding to an image feature and/or an audio feature may also be acquired by recognizing the target image feature and the target audio feature in a video, thus, the advertisement loaded into the video may be perfectly integrated with the video, and a user will not be influenced when watching the video. Additionally, when the number of times that the advertisement is loaded to the video is too large, a loading of the advertisement to the video would be stopped, thereby the influence on user experience may be avoided.

With the description of the above method embodiments, one skilled in the art may clearly understand that the disclosure may be implemented by the aid of software and necessary universal hardware platforms; of course, the disclosure may also be implemented by hardware; but in many cases, the former solution is preferred. Based on such an understanding, the essential part of the technical solutions in the embodiments of the disclosure, or in other words, the part that contributes to the prior art, may be embodied in the form of a software product that is stored in a storage medium, and includes a number of instructions that can enable a computer device (which may be a personal computer, a server or a network device, etc.) to implement all or part of the steps of the method according to each embodiment of the disclosure. The storage medium includes various mediums that may be used to store program codes, such as Read-Only Memory (ROM), Random-Access Memory (RAM), magnetic disc or compact disc, etc.

Additionally, for implementing above various embodiments, one embodiment of the disclosure further provides a device for loading advertisements to video, wherein said device is provided in a terminal. As shown in FIG. 6, the device includes: a video monitoring unit 10, an advertisement judging unit 20 and an advertisement loading unit 30, wherein:

the video monitoring unit 10 is configured for monitoring content information of a video;

the advertisement judging unit 20 is configured for judging whether there is an advertisement matching with the content information in an advertisement library; and

the advertisement loading unit 30 is configured for loading the advertisement to the video when there is an advertisement matching with the content information in the preset advertisement library.

In the device for loading advertisements to video according to the disclosure, by monitoring the content information of a video played, it is judged whether there is an advertisement matching with the content information of the video in an advertisement library; if yes, the corresponding advertisement will be loaded to the video, so that the advertisement loaded to the video may be perfectly integrated with the content of the video. Thus, an excellent advertising effect may be attained without a need to directly modify the movie content of the video, and the phenomenon of user antipathy caused by the mismatch between the video content and the advertisement loaded in the traditional advertising mode may also be avoided.

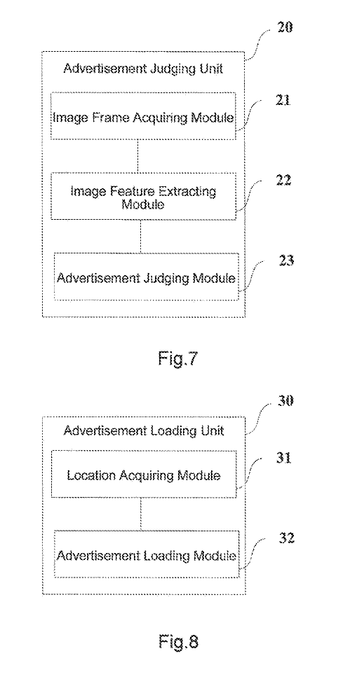

In another embodiment of the disclosure based on FIG. 6, as shown in FIG. 7, the content information is image information, and the advertisement judging unit 20 includes: an image frame acquiring module 21, an image feature extracting module 22 and an advertisement judging module 23, wherein:

the image frame acquiring module 21 is configured for acquiring a key image frame in the video;

the image feature extracting module 22 is configured for extracting a target image feature from the key image frame; and

the advertisement judging module 23 is configured for judging whether there is an advertisement in the advertisement library matching with the target image feature.

In another embodiment of the disclosure based on FIG. 6, as shown in FIG. 8, the advertisement loading unit 30 includes: a location acquiring submodule 31 and an advertisement loading submodule 32, wherein:

the location acquiring module 31 is configured for acquiring a target location of the target image feature in the key image frame; and

the advertisement loading module 32 is configured for loading the advertisement matching with the image information to the target location in the key image frame.

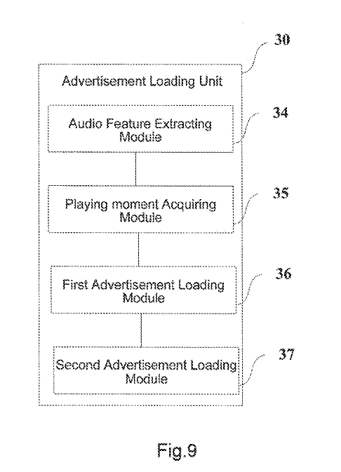

In another embodiment of the disclosure based on FIG. 6, as shown in FIG. 9, the content information is audio information, and the advertisement loading unit 30 includes: an audio feature extracting module 34, a playing moment acquiring module 35, a first advertisement loading module 36 and a second advertisement loading module 37, wherein:

the audio feature extracting module 34 is configured for extracting a target audio feature from the audio information;

the playing moment acquiring module 35 is configured for acquiring a playing moment of the target audio feature in the video;

the first advertisement loading module 36 is configured for loading an advertisement matching with the target audio feature at the playing moment of the video;

and

the second advertisement loading module 37 is configured for loading an advertisement matching with the target audio feature to a preset location in a video display interface.

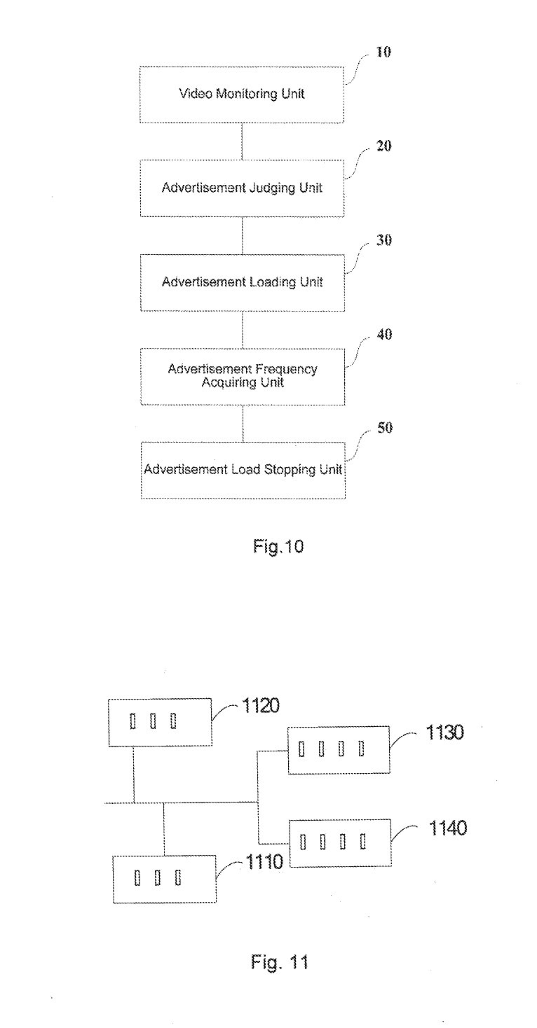

In another embodiment of the disclosure based on FIG. 6, as shown in FIG. 10, the device further includes: an advertisement frequency acquiring unit 40 and an advertisement load stopping unit 50, wherein:

the advertisement frequency acquiring unit 40 is configured for acquiring the number of times that an advertisement is loaded to the video; and

the advertisement load stopping unit 50 is configured for stopping a load of the advertisement to the video when the number of times that the advertisement is loaded is greater than a preset threshold.

In the method and the device for loading advertisements to video according to the disclosure, by monitoring the content information of a video played, it is judged whether there is an advertisement matching with the content information of the video in an advertisement library; if yes, the corresponding advertisement will be loaded to the video, so that the advertisement loaded to the video may be perfectly integrated with the content of the video. Thus, an excellent advertising effect may be attained without a need to directly modify the movie content of the video, and the phenomenon of user antipathy caused by the mismatch between the video content and the advertisement loaded in the traditional advertising mode may also be avoided.

Additionally, by recognizing the target image feature and the target audio feature in a video, it is possible to acquire an advertisement corresponding to the image feature and/or audio, thus the advertisement loaded into the video may be perfectly integrated with the video, and a user will not be influenced when watching the video. Additionally, when the number of times that the advertisement is loaded to the video is too large, it stops loading the advertisement to the video, so as to avoid an influence on user experience.

The present disclosure provides a non-transitory computer-readable storage medium on which computer executable instructions are stored, when executed, the computer executable instructions may carry out a method for loading advertisements to video according to any one of the above method embodiments.

FIG. 11 is a diagram illustrating a hardware structure of an electronic device on which a method for loading advertisements to video is executed provided by an embodiment of the present disclosure. As shown in FIG. 11, the electronic device includes:

at least one processor 1110 and a memory 1120, wherein only one processor 1110 is illustratively shown in FIG. 11.

The device for carrying out a method for loading advertisements to video may also include: an input device 1130 and an output device 1140.

The processor 1110, memory 1120, input device 1130 and output device 1140 may be connected via a bus or other means, wherein a connecting bus is illustratively shown in FIG. 11.

The memory 1120, as a non-volatile computer readable storage medium, may be used to store non-volatile software programs, non-volatile computer executable programs and modules, such as the program commands/modules corresponding to the method for loading advertisements to video according to the embodiments in the present disclosure (such as the video monitoring unit 10, the advertisement judging unit 20, and the advertisement loading unit 30 illustrated in FIG. 6). The processor 1110, by running non-volatile software programs, commands and modules stored in the memory 1120, performs various functional applications and data processing of the server, i.e., carries out the method for loading advertisements to video according to the above method embodiments.

The memory 1120 may include a program storage area and a data storage area, wherein the program storage area may be used to store application programs needed by an operating system or by at least one function, and the data storage area may be used to store data created by running the device for amplifying a video image, and the like. Moreover, the memory 1120 may include a high speed random access memory, and also may include a non-volatile memory, such as at least one disk memory, flash memory, or other non-volatile solid state memory. According to some embodiments, the memory 1120 may optionally include memories that are remotely setup with respect to the processor 1110, and these remote memories may be connected to the device for amplifying a video image via a network connection. An example of such a network includes, but not limited to, internet, intranet, local area network, mobile communication network, and a combination thereof.

The input device 1130 may receive input digital or character information, and generate key signal inputs concerned with user setting and functional control of the device for loading advertisements to video. The output device 1140 may include displaying means such as a display screen.

The at least one module is stored in the memory 1120, and, when run by the at least one processor 1110, executes the method for loading advertisements to video according to any one of the above method embodiments.

The above product may execute the method provided by the embodiments of the present disclosure, and has functional modules and beneficial effects corresponded to the executed method. As for technical details that are not elaborated in the present embodiments, reference can be made to the method provided by the embodiments of the present disclosure.

The electronic device of the embodiments of the present disclosure exists in various forms, including but not limited to:

(1) mobile communication devices, characterized in having a function of mobile communication mainly aimed at providing speech and data communication, wherein such terminal includes: smart phone (such as iPhone), multimedia phone, functional phone, low end phone and the like;

(2) ultra mobile personal computer devices, which falls in a scope of personal computer, has functions of calculation and processing, and generally has characteristics of mobile internet access, wherein such terminal includes: PDA, MID and UMPC devices, such as iPad;

(3) portable entertainment devices, which can display and play multimedia contents, anc includes audio or video player (such as iPod), portable game console, E-book and intelligent toys and portable vehicle navigation devices;

(4) server, a device for providing computing service, constituted by processor, hard disc, internal memory, system bus, and the like, which has a framework similar to that of a computer, but is demanded for superior processing ability, stability, reliability, security, extendibility and manageability due to that high reliable services are desired; and

(5) other electronic devices having a function of data interaction.

The above mentioned apparatus embodiments are merely exemplary, wherein the unit illustrated as a separated component may be or may not be physically separated, the component illustrated as a unit may be or may not be a physical unit, in other words, may be either disposed in some place or distributed to a plurality of network units. All or part of modules may be selected as actually required to realize the objects of the present disclosure. Such selection may be understood and implemented by ordinary skill in the art without creative work.

According to the description in connection with the above embodiments, it can be clearly understood by those of ordinary skill in the art that various embodiments can be realized by means of software in combination with necessary universal hardware platform, and certainly, may further be realized by means of hardware. Based on such understanding, the above technical solutions in substance or the part thereof that makes a contribution to the prior art may be embodied in a form of a software product which can be stored in a computer-readable storage medium, such as ROM/RAM, magnetic disk and compact disc, and includes several instructions for allowing a computer apparatus (which may be a personal computer, a server, a network device or the like) to execute the methods described in various embodiments or some parts thereof.

Finally, it should be stated that, the above embodiments are merely used for illustrating the technical solutions of the present disclosure, rather than limiting them. Although the present disclosure has been illustrated in details in reference to the above embodiments, it should be understood by those of ordinary skill in the art that some modifications can be made to the technical solutions of the above embodiments, or part of technical features can be substituted with equivalents thereof. Such modifications and substitutions do not cause the corresponding technical features to depart in substance from the spirit and scope of the technical solutions of various embodiments of the present disclosure.

1. A method for loading advertisements to video, comprising:
monitoring content information of the video;
judging whether there is an advertisement matching with the content information in an advertisement library; and
loading the advertisement to the video when there is an advertisement matching with the content information in the preset advertisement library.

2. The method for loading advertisements to video according to claim 1, wherein the content information is image information, and the step of judging whether there is an advertisement matching with the content information in the advertisement library comprises:
acquiring a key image frame in the video;
extracting a target image feature from the key image frame; and
judging whether there is an advertisement matching with the target image feature in the advertisement library.

3. The method for loading advertisements to video according to claim 2, wherein the step of the loading the advertisement to the video comprises:
acquiring a target location of the target image feature in the key image frame; and
loading the advertisement matching with the image information to the target location in the key image frame.

4. The method for loading advertisements to video according to claim 1, wherein the content information is audio information, and the step of loading the advertisement to the video that is played comprises:
extracting a target audio feature from the audio information;
acquiring a playing moment of the target audio feature in the video; and
loading the advertisement matching with the target audio feature at the playing moment of the video, and loading the advertisement matching with the target audio feature to a preset location in a video display interface.

5. The method for loading advertisements to video according to claim 1, further comprising:
acquiring the number of times that the advertisement is loaded to the video; and
stopping a continuous load of the advertisement to the video when the number of times that the advertisement is loaded is greater than a preset threshold.

6-10. (canceled)

11. A non-transitory computer-readable storage medium on which computer executable instructions are stored, wherein the computer executable instructions are configured to:
monitor content information of the video;
judge whether there is an advertisement matching with the content information in an advertisement library; and
load the advertisement to the video when there is an advertisement matching with the content information in the preset advertisement library.

12. The non-transitory computer-readable storage medium according to claim 11, wherein the computer executable instructions are further configured to:
acquire a key image frame in the video;
extract a target image feature from the key image frame; and
judge whether there is an advertisement matching with the target image feature in the advertisement library.

13. The non-transitory computer-readable storage medium according to claim 12, wherein the computer executable instructions are further configured to:
acquire a target location of the target image feature in the key image frame; and
load the advertisement matching with the image information to the target location in the key image frame.

14. The non-transitory computer-readable storage medium according to claim 11, wherein the computer executable instructions are further configured to:
extract a target audio feature from the audio information;
acquire a playing moment of the target audio feature in the video; and
load the advertisement matching with the target audio feature at the playing moment of the video, and load the advertisement matching with the target audio feature to a preset location in a video display interface.

15. The non-transitory computer-readable storage medium according to claim 11, wherein the computer executable instructions are further configured to:
acquire the number of times that the advertisement is loaded to the video; and
stop a continuous load of the advertisement to the video when the number of times that the advertisement is loaded is greater than a preset threshold.

16. An electronic device, comprising
at least one processor; and
a memory in communication connection with the at least one processor,
wherein the at least one processor is configured to:
monitor content information of the video;
judge whether there is an advertisement matching with the content information in an advertisement library; and
load the advertisement to the video when there is an advertisement matching with the content information in the preset advertisement library.

17. The electronic device according to claim 16, wherein the content information is image information, and the at least one processor is further configured to:
acquire a key image frame in the video;
extract a target image feature from the key image frame; and
judge whether there is an advertisement matching with the target image feature in the advertisement library.

18. The electronic device according to claim 17, wherein the at least one processor is further configured to:
acquire a target location of the target image feature in the key image frame; and
load the advertisement matching with the image information to the target location in the key image frame.

19. The electronic device according to claim 16, wherein the content information is audio information, and the at least one processor is further configured to:
extract a target audio feature from the audio information;
acquire a playing moment of the target audio feature in the video; and
load the advertisement matching with the target audio feature at the playing moment of the video, and load the advertisement matching with the target audio feature to a preset location in a video display interface.

20. The electronic device according to any one of claim 16, wherein the at least one processor is further configured to:
acquire the number of times that the advertisement is loaded to the video; and
stop a continuous load of the advertisement to the video when the number of times that the advertisement is loaded is greater than a preset threshold.
